(19) United States
(12) Patent Application Publication
(10) Pub. No.: US 2022/0259751 A1
(43) Pub. Date: Aug. 18, 2022

(54) A Separator for Alkaline Water Electrolysis

(71) Applicant: AGFA-GEVAERT NV, Mortsel (BE)

(72) Inventor: Willem MUES, Mortsel (BE)

(73) Assignee: AGFA-GEVAERT NV, Mortsel (BE)

(21) Appl. No.: 17/624,628

(22) PCT Filed: Jun. 26, 2020
(86) PCT No.: PCT/EP2020/067996

§ 371 Date: Jan. 4, 2022

(30) Foreign Application Priority Data
Jul. 5, 2019 (EP) 19184571.8

(51) Int. Cl. C25B 13/02; C25B 9/19; C25B 13/08; C25B 13/05

(52) U.S. Cl. CPC C25B 13/02; C25B 9/19; C25B 1/04; C25B 13/05; C25B 13/08

(57) ABSTRACT

A separator for alkaline water electrolysis (1) comprising a porous hydrophilic polymer layer (20), the porous hydrophilic polymer layer comprising a polymer resin and hydrophilic inorganic particles, characterized in that the inorganic particles are barium-sulfate particles having a particle size D50 of 0.7 pm or less.

### TECHNICAL FIELD OF THE INVENTION

The present invention relates to a separator for alkaline water electrolysis and to a method to produce such separators.

### BACKGROUND ART FOR THE INVENTION

Nowadays, hydrogen is used in several industrial processes. For example its use as raw material in the chemical industry and as a reducing agent in the metallurgic industry. Hydrogen is a fundamental building block for the manufacture of ammonia, and hence fertilizers, and of methanol, used in the manufacture of many polymers. Refineries, where hydrogen is used for the processing of intermediate oil products, are another area of use.

Hydrogen is also being considered an important future energy carrier, which means it can store and deliver energy in a usable form. Energy is released by an exothermic combustion reaction with oxygen thereby forming water. During such combustion reaction, no greenhouse gases containing carbon are emitted.

As the production of electricity from renewables increases, so will the need for energy storage and transportation. Many of these sources, especially solar and wind, are located far from population centers and produce electricity only part of the time. Hydrogen may be the perfect carrier for this energy. It can store the energy and distribute it to wherever it is needed.

Alkaline water electrolysis is an important manufacturing process of hydrogen.

In an alkaline water electrolysis cell, a so-called separator or diaphragm is used to separate the electrodes of different polarity to prevent a short circuit between these electronic conducting parts (electrodes) and to prevent the recombination of H₂ (formed at the cathode) and O₂ (formed at the anode) by avoiding gas crossover. While serving in all these functions, the separator should also be a highly ionic conductor for transportation of OH⁻ ions from the cathode to the anode.

EP0232923 (Hydrogen Systems) discloses an ion-permeable diaphragm prepared by immersing an organic fabric in a dope solution, which is applied on a glass sheet. After phase inversion, the diaphragm is then removed from the glass sheet. There is however a large difference between the maximum pore diameters of both sides of a separator prepared according to the method disclosed in EP-A 0232923.

EP-A 1776490 (VITO) discloses a process of preparing an ion-permeable web-reinforced separator membrane. The process leads to a membrane with symmetrical characteristics. The process includes the steps of providing a web and a suitable dope solution, guiding the web in a vertical position, equally coating both sides of the web with the dope solution to produce a dope coated web, and applying a symmetrical surface pore formation step and a symmetrical coagulation step to the dope coated web to produce a web-reinforced membrane.

WO2009/147084 and WO2009/147086 (Agfa Gevaert and VITO) discloses manufacturing technology to produce a membrane with symmetrical characteristics as described in EP-A 1776490.

A typical dope solution used to manufacture separators for alkaline water electrolysis comprise hydrophilic inorganic particles. The most commonly used hydrophilic inorganic particles are zirconium oxide particles.

A disadvantage of zirconium oxide based separators are however their high cost.

There is thus a need for high quality but less expensive separators making hydrogen production via alkaline water electrolysis more cost effective.

### SUMMARY OF THE INVENTION

It is an object of the invention to provide a separator for alkaline water electrolysis resulting in a more cost effective hydrogen production.

This object is realized with the separator as defined in claim 1.

Further objects of the invention will become apparent from the description hereinafter.

### BRIEF DESCRIPTION OF THE DRAWINGS

FIG. 1 shows schematically an embodiment of a separator according to the present invention.

FIG. 2 shows schematically another embodiment of a separator according to the present invention.

FIG. 3 shows schematically an embodiment of a manufacturing method of a separator according to the present invention.

FIG. 4 shows schematically another embodiment of a manufacturing method of a separator according to the present invention.

### DETAILED DESCRIPTION OF THE INVENTION

Separator for Alkaline Water Electrolysis

The separator for alkaline water electrolysis (1) according to the present invention comprises a porous hydrophilic layer (20), the porous hydrophilic layer comprising a polymer resin and hydrophilic inorganic particles, characterized in that the inorganic particles are bariumsulfate particles having a particle size D50 of 0.7 μm or less.

A preferred separator further comprises a porous support (10). Such a separator is often referred to as a reinforced separator.

A preferred separator comprises two porous hydrophilic layers (30b, 40b) contiguous with both sides of a porous support (10). Both layers may be the same or different. Preferably, both layers are the same.

A described below in more detail a preferred separator is prepared by the application on at least one surface of a porous support a coating solution, typically referred to as a dope solution, comprising the polymer resin, the bariumsulfate particles and a solvent. The porous hydrophilic layer is then obtained after a phase inversion step wherein the polymer resin forms a three-dimensional porous polymer network.

Upon application of the dope solution on a surface of the porous support, the dope solution impregnates the porous support. The porous support is preferably completely impregnated with the dope solution.

When two dope solutions are applied on both surfaces of the porous support, both dope solutions impregnate the support. Also in this embodiment a completely impregnated porous support is preferred.

After phase inversion, the impregnation of the porous support ensures that the three-dimensional porous polymer network also extends into the porous substrate. This results in a good adhesion of the porous hydrophilic layer to the porous support.

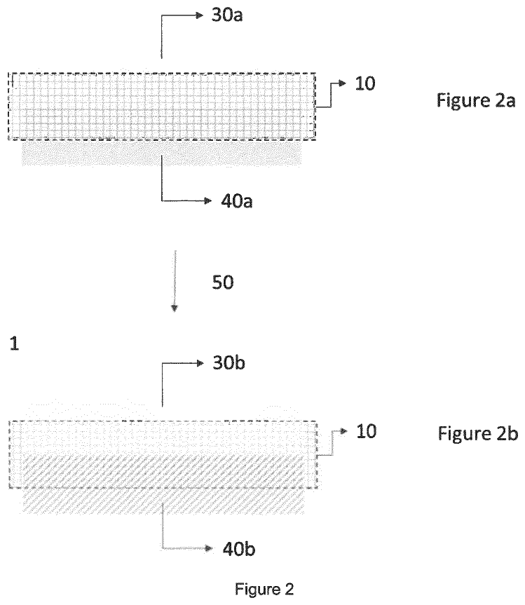

A preferred separator (1) is schematically shown in FIG. 2.

In FIG. 2a, a dope solution has been applied on either side of a porous support (10) and the porous support is fully impregnated with the applied dope solution. The dope solutions are preferably the same. The applied dope layers are referred to as 30a and 40a.

After a phase inversion step (50), a separator is obtained as shown in FIG. 2b, comprising a porous support (10) and on either side of the support a porous hydrophilic layer (30b, 40b).

The pore diameter of the separator has to be sufficiently small to prevent recombination of H₂ and O₂ by avoiding gas crossover. On the other hand, to ensure efficient transportation of OH⁻ ions from the cathode to the anode, larger pore diameters are preferred. An efficient transportation of the OH⁻ ions requires an efficient penetration of electrolyte into the separator.

The maximum pore diameter (PDmax) of the separator is preferably between 0.05 and 2 μm, more preferably between 0.10 and 1 μm, most preferably between 0.15 and 0.5 μm.

Both sides of the separator may have identical or different maximum pore diameters.

A preferred separator of which both sides have identical pore diameters is disclosed in EP-A 1776480 and WO2009/147084 mentioned above.

A preferred separator of which both sides have different pore diameters is disclosed in PCT/EP2018/068515 (filed Sep. 7, 2018).

The pore diameter referred to is preferably measured using the Bubble Point Test method as described below. That method is described in American Society for Testing and Materials Standard (ASMT) Method F316.

The porosity of the separator is preferably between 30 and 70%, more preferably between 40 and 60%.

The thickness of the separator is preferably between 100 and 1000 μm, more preferably between 200 and 750 μm. If the thickness of the separator is less than 100 μm, its physical strength maybe insufficient, when the thickness is above 1000 μm, the electrolysis efficiency may decrease.

Porous Support

The porous support is used to reinforce the separator to ensure its mechanical strength.

The porous support may be selected from the group consisting of a porous fabric, a porous metal plate and a porous ceramic plate.

The porous support is preferably a porous fabric, more preferably a porous polymer fabric.

Suitable porous polymer fabrics are prepared from polypropylene (PP), polyethylene (PE), polysulfone (PS), polyphenylene sulfide (PPS), polyamide/nylon (PA), polyethersulfone (PES), polyphenyl sulfone (PPS), polyethylene terephthalate (PET), polyether-ether ketone (PEEK), sulfonated polyether-ether keton (s-PEEK), monochlorotrifluoroethylene (CTFE), copolymers of ethylene with tetrafluorethylene (ETFE) or chlorotrifluorethylene (ECTFE), polyimide, polyether imide and m-aramide.

A preferred porous support is prepared from polypropylene (PP) or polyphenylene sulphide (PPS), more preferably from polyphenylene sulphide (PPS). The use of polyphenylene sulfide allows the porous support to exhibit high resistance to high-temperature, high concentration alkaline solutions and exhibit high chemical stability against active oxygen evolved from an anode during water electrolysis process. In addition, with the use of polyphenylene sulfide, the porous support can easily be processed into various forms such as a woven fabric or a non-woven fabric, and can thus be appropriately modified according to the intended application or intended use environment.

The porous polymer fabric may be woven or non-woven.

The open area of the porous support is preferably between 20 and 80%, more preferably between 40 and 70%, to ensure good penetration of the electrolyte into the support.

The porous support has pores or mesh openings preferably having an average diameter between 100 and 1000 μm, more preferably between 300 and 700 μm.

The density of the porous support is preferably between 0.1 to 0.7 g/cm³.

The support preferably has a thickness between 100 and 750 μm, more preferably between 125 and 300 μm.

The porous support is preferably a continuous web to enable a manufacturing process as disclosed in EP-A 1776490 and WO2009/147084.

Porous Hydrophilic Layer

The porous hydrophilic layer comprises a polymer resin and hydrophilic particles.

The hydrophilic particles are bariumsulfate particles having a D50 particle size of 0.7 μm or less.

D50 is a well known value to characterize a particle size distribution. It is also known as the median diameter or the medium value of a particle size distribution. It is the value of the particle diameter at 50% in the cumulative distribution. For example, if D50=0.7 um, then 50% of the particles in the sample have a diameter larger than 0.7 um, and 50% have a diameter smaller than 0.7 um.

The polymer resin forms a three dimensional porous network, the result of a phase inversion step in the preparation of the separator, as described below.

The polymer resin is preferably selected from the group consisting of polysulfone (PSU), polyether sulfone (PES), polyphenylene sulfone (PPS), polyvinylidene fluoride (PVDF), polyacrylonitrile (PAN), polyethyleneoxide (PEO), polymethylmethacrylate (PMMA) and copolymers thereof.

PVDF and vinylidenefluoride (VDF)-copolymers are preferred for their oxidation/reduction resistance and film-forming properties. Among these, terpolymers of VDF, hexanefluoropropylene (HFP) and chlorotrifluoroethylene (CTFE) are preferred for their excellent swelling properties, heat resistance and adhesion to electrodes.

Particular preferred polymer resins are selected from polysulfones, polyether sulfones and polyphenyl sulfones.

The molecular weight (Mw) of polysulfones, polyether sulfones and polyphenol sulfones is preferably between 10 000 and 500 000, more preferably between 25 000 and 250 000. When the Mw is too low, the physical strength of the porous hydrophilic layer becomes insufficient. When the Mw is too high, the viscosity of the dope solution might become too high.

A particularly preferred polymer resin is polysulfone, as disclosed in for example EP-A 3085815, paragraph [0027] to [0032].

Another preferred polymer resin is a polyether sulfone (PES), disclosed in EP-A 3085815, paragraphs [0021] to [0026]. The polyether sulfone may be mixed with polysulfone as also disclosed in EP-A 3085815.

The hydrophilic layer also comprises hydrophilic particles, wherein the hydrophilic particles are bariumsulfate particles having a D50 particle size of 0.70 μm or less, preferably of 0.50 μm or less, more preferably of 0.35 μm or less, most preferably of 0.30 μm or less.

It has been found that using bariumsulfate particles having a D50 particle size above 0.7 μm results in a less efficient hydrogen production due to an increase of the ionic resistance of the alkaline electrolysis cell.

The amount of bariumsulfate relative to the total dry weight of the porous hydrophilic layer is preferably at least 50 wt %, more preferably at least 75 wt %.

The porous hydrophilic layer may comprise in addition to the bariumsulfate particles other hydrophilic particles. Such other hydrophilic particles are preferably metal oxides or hydroxides. Preferred other hydrophilic particles are ZrO₂, TiO₂, Al₂O₃, and MgOH.

According to a particular preferred embodiment, the porous hydrophilic layer comprises no other hydrophilic particles besides BaSO₄ particles.

When using BaSO₄ particles having a D50 particle size of less than or equal to 0.7 μm, a more cost effective separator is realized when compared with the conventional separators using zirconium oxide.

The weight ratio of hydrophilic particles to polymer resin is preferably more then 60/40, more preferably more than 70/30, most preferably more than 75/25. Particularly preferred, the weight ratio of the hydrophilic particles, preferably BaSO4 referred to above, to polymer resin is 80/20 or more.

Manufacturing of the Separator for Alkaline Water Electrolysis

The method for manufacturing a separator for alkaline water electrolysis comprises the steps of:
applying a dope solution as described below on a substrate; and
subjecting the applied dope solution to phase inversion.

In a preferred method the substrate is a porous support as described above and a dope solution is applied on the porous substrate.

A separator comprising such a porous support may be referred to as a reinforced separator.

In a particular preferred method, a dope solution is applied on either side of the porous support.

A preferred method of manufacturing a reinforced separator is disclosed in EP-A 1776490 and WO2009/147084 for symmetric separators and PCT/EP2018/068515 (filed Sep. 7, 2018) for asymmetric separators. These methods result in web-reinforced separators wherein the web, i.e. the porous support, is nicely embedded in the separator, without appearance of the web at a surface of the separator.

Other manufacturing methods that may be used are disclosed in EP-A 3272908.

Dope Solution

The dope solution comprises a polymer resin as described above, barium sulfate particles as described above and a solvent.

The solvent of the dope solution is preferably an organic solvent wherein the polymer resin can be dissolved. Moreover, the organic solvent is preferably miscible in water.

The solvent is preferably selected from N-methyl-2-pyrrolidone (NMP), N-ethyl-pyrrolidone (NEP), N-butyl-pyrrolidone (NBP), N,N-dimethylformamide (DMF), formamide, dimethylsulfoxide (DMSO), N,N-dimethylacetamide (DMAC), acetonitrile, and mixtures thereof.

A highly preferred solvent, especially for health and safety reasons, is NBP.

The dope solution may further comprise other ingredients to optimize the properties of the obtained polymer layers, for example their porosity and the maximum pore diameter at their outer surface.

The dope solution preferably comprises a pore forming promoting agent such as polyvinylpyrrolidone (PVP), polyvinylalcohol (PVA), polyvinylacetate (PVAc), methylcellulose and polyethylene oxide. These compounds may have an influence on the maximum pore diameter and/or the porosity of the porous polymer layers.

The concentration of these pore forming promoting agents in the dope solution is preferably between 0.1 and 15 wt %, more preferably between 0.5 and 10 wt % relative to the total weight of the dope solution.

The dope solution preferably comprises a hydrophilizing and stabilizing agents selected from the group consisting of polypropylene glycol, ethylene glycol, tripropylene glycol, polyethylene glycol, glycerol, polyhydric alcohols, dibutyl phthalate (DBP), diethyl phthalate (DEP), diundecyl phthalate (DUP), isononanoic acid or neo decanoic acid.

In a particular preferred embodiment, the dope solution comprises glycerol. Glycerol also has an influence on the pore formation in the porous polymer layer.

The concentration of glycerol is preferably between 0.1 and 15 wt %, more preferably between 0.5 and 5 wt % relative to the total weight of the dope solution.

In case two polymers layers are applied on the porous support, the dope solution used for both layers may be identical or different from each other.

Applying the Dope Solution

The dope solution may be applied on the surface of a substrate, preferably a porous support, by any coating or casting technique.

A preferred coating technique is for example extrusion coating.

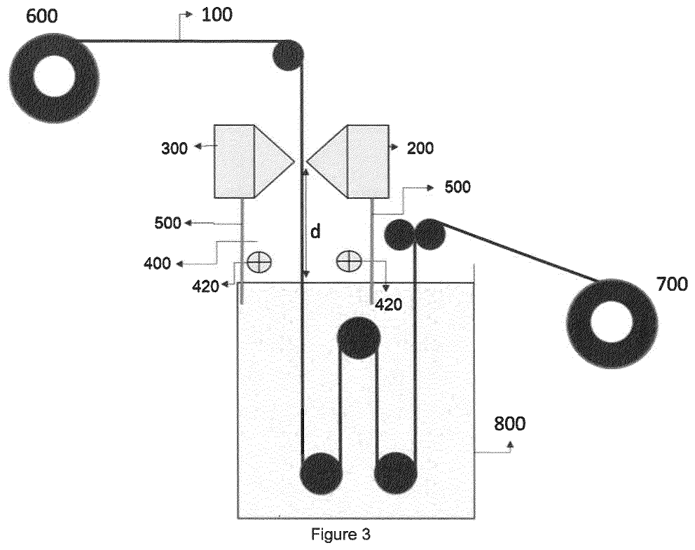

In a highly preferred embodiment, the dope solutions are applied by a slot die coating technique wherein two slot coating dies (FIGS. 3 and 4, 200 and 300) are located on either side of a porous support.

The slot coating dies are capable of holding the dope solution at a predetermined temperature, distributing the dope solutions uniformly over the support, and adjusting the coating thickness of the applied dope solutions.

The viscosity of the dope solutions, when used in a slot die coating technique, is preferably between 1 and 500 Pa.s, more preferably between 10 and 100 Pa.s, at coating temperature and at a shear rate of 1 s⁻¹.

The dope solutions are preferably shear-thinning. The ratio of the viscosity at a shear rate of 1 s⁻¹ to the viscosity at a shear rate of 100 s⁻¹ is preferably at least 2, more preferably at least 2.5, most preferably at least 5.

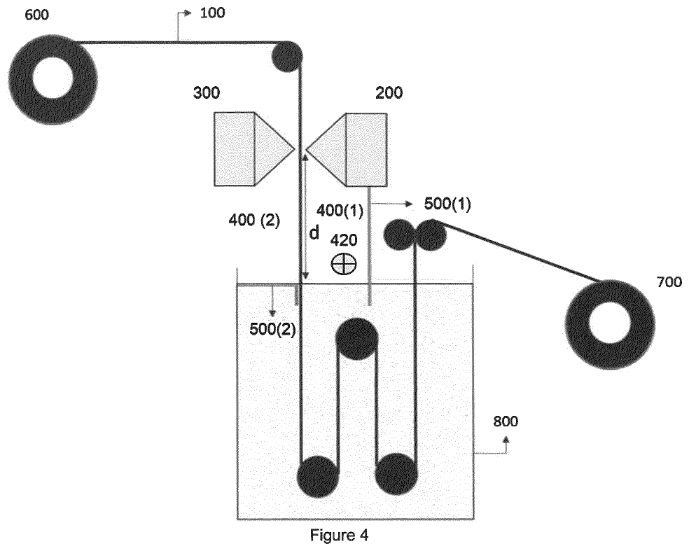

The porous support is preferably a continuous web, which is transported downwards between the slot coating dies (200, 300) as shown in FIGS. 3 and 4.

Immediately after the application, the porous support becomes impregnated with the dope solutions.

Preferably, the porous support becomes fully impregnated with the applied dope solutions.

However, even when the porous support is completely impregnated with the dope solution, the thickness of the separator is larger than the thickness of the porous support. This means that on both sides of the impregnated porous support, a “pure” dope layer is present, shown in FIG. 2.

Phase Inversion Step

After applying the dope solution onto a substrate, the applied dope solution is subjected to phase inversion. In the phase inversion step, the applied dope solution is transformed into a porous hydrophilic layer.

In case a porous support is used however, the porous support is a part of the separator. The porous support gives the separator more physical strength. Such a separator is typically referred to as a reinforced separator.

In a preferred embodiment, both dope solutions applied on a porous support are subjected to phase inversion.

The phase inversion step preferably comprises a so-called Liquid Induced Phase Separation (LIPS) step and preferably a combination a Vapour Induced Phase Separation (VIPS) step and a LIPS step.

Both LIPS and VIPS are non-solvent induced phase-inversion processes.

In a LIPS step the porous support coated on both sides with the dope solution is contacted with a non-solvent that is miscible with the solvent of the dope solution.

Typically, this is carried out by immersing the porous support coated on both sides with the dope solutions into a non-solvent bath, also referred to as coagulation bath.

The non-solvent is preferably water, mixtures of water and an aprotic solvent selected from the group consisting of N-methylpyrrolidone (NMP), dimethylformamide (DMF), dimethylsulfoxide (DMSO) and dimethylacetamide (DMAC), water solutions of water-soluble polymers such as PVP or PVA, or mixtures of water and alcohols, such as ethanol, propanol or isopropanol.

The non-solvent is most preferably water.

The temperature of the water bath is preferably between 20 and 90° C., more preferably between 40 and 70° C.

The transfer of solvent from the coated polymer layer towards the non-solvent bath and of non-solvent into the polymer layer leads to phase inversion and the formation of a three-dimensional porous polymer network. The impregnation of the applied dope solution into the porous support results in a sufficient adhesion of the obtained hydrophilic layers onto the porous support.

In a preferred embodiment, the continuous web (100) coated on either side with a dope solution is transported downwards, in a vertical position, towards the coagulation bath (800) as shown in FIGS. 3 and 4.

In a VIPS step, the porous support coated with the dope solutions is exposed to non-solvent vapour, preferably humid air.

Preferably, the coagulation step included both a VIPS and a LIPS step. Preferably, the porous support coated with the dope solutions is first exposed to humid air (VIPS step) prior to immersion in the coagulation bath (LIPS step).

In the manufacturing method shown in FIG. 3, VIPS is carried out in the area 400, between the slot coating dies (200, 300) and the surface of the non-solvent in the coagulation bath (800), which is shielded from the environment with for example thermal isolated metal plates (500).

The extent and rate of water transfer in the VIPS step can be controlled by adjusting the velocity of the air, the relative humidity and temperature of the air, as well as the exposure time.

The exposure time may be adjusted by changing the distanced between the slot coating dies (200, 300) and the surface of the non-solvent in the coagulation bath (800) and/or the speed with which the elongated web 100 is transported from the slot coating dies towards the coagulation bath.

The relative humidity in the VIPS area (400) may be adjusted by the temperature of the coagulation bath and the shielding of the VIPS area (400) from the environment and from the coagulation bath.

The speed of the air may be adjusted by the rotating speed of the ventilators (420) in the VIPS area (404).

The VIPS step carried out on one side of the separator and on the other side of the separator, resulting in the second porous polymer layer, may be identical (FIG. 3) or different (FIG. 4) from each other.

After the phase inversion step, preferably the LIPS step in the coagulation bath, a washing step may be carried out.

After the phase inversion step, or the optional washing step, a drying step is preferably carried out.

FIGS. 3 and 4 schematically illustrates a preferred embodiment to manufacture a separator according to the present invention.

The porous support is preferably a continuous web (100).

The web is unwinded from a feed roller (600) and guided downwards in a vertical position between two coating units (200) and (300).

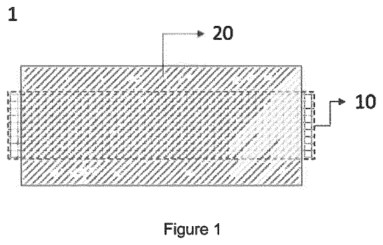

With these coating units, a dope solution is coated on either side of the web. The coating thickness on either side of the web may be adjusted by optimizing the viscosity of the dope solutions and the distance between the coating units and the surface of the web. Preferred coating units are described in EP-A 2296825, paragraphs [0043], [0047], [0048], [0060], [0063], and FIG. 1.

The web coated on both sides with a dope solution is then transported over a distance d downwards towards a coagulation bath (800).

In the coagulation bath, the LIPS step is carried out.

The VIPS step is carried out before entering the coagulation bath in the VIPS areas. In FIG. 3, the VIPS area (400) is identical on both sides of the coated web, while in FIG. 4, the VIPS areas (400(1)) and (400(2)) on either side of the coated web are different.

The relative humidity (RH) and the air temperature in de VIPS area may be optimized using thermally isolated metal plates. In FIG. 3, the VIPS area (400) is completely shielded from the environment with such metal plates (500). The RH and temperature of the air is then mainly determined by the temperature of the coagulation bath. The air speed in the VIPS area may be adjusted by a ventilator (420).

In FIG. 4 the VIPS areas (400(1)) and (400(2)) are different from each other. The VIPS area (400(1)) on one side of the coated web is identical to the VIPS area (400) in FIG. 3. The VIPS area (400(2)) on the other side of the coated web is different from the area (400(1)). There is no metal plate shielding the VIPS area (400(2)) from the environment. However, the VIPS area (400(2)) is now shielded from the coagulation bath by a thermally isolated metal plate (500(2)). In addition, there is no ventilator present in the VIPS area 400(2). This results in a VIPS area (400(1)) having a higher RH and air temperature compared to the RH and air temperature of the other VIPS area (400(2)).

A high RH and/or a high air speed in a VIPS area typically result in a larger maximum pore diameter.

The RH in one VIPS area is preferably above 85%, more preferably above 90%, most preferably above 95% while the RH in another VIPS area is preferably below 80%, more preferably below 75%, most preferably below 70%.

After the phase separation step, the reinforced separator is then transported to a rolled up system (700).

A liner may be provided on one side of the separator before rolling up the separator and the applied liner.

### EXAMPLES

Materials

All materials used in the following examples were readily available from standard sources such as ALDRICH CHEMICAL Co. (Belgium) and ACROS (Belgium) unless otherwise specified. The water used was deionized water.

PPS-fabric, a polyphenylenesulfide porous support (woven, thickness=350 μm, open area=60%), commercially available from NBC Inc.

ZrO₂(1), type E101 available from MEL-Chemicals having a D50 particle size of 0.3 μm.

ZrO₂(1), type SRP-2 available from DKKK having a D50 particle size of 1.2 μm.

BaSO4(1), type Blanc Fixe N available from Sachtleben having a D50 particle size of 3 μm.

BaSO4(2), type Blanc Fixe F available from Sachtleben. having a D50 particle size of 1 μm.

BaSO4(3), type Blanc Fixe Micro Plus available from Sachtleben. having a D50 particle size of 0.7 μm.

BaSO4(4), type Bariace B-34 available from Sakai Chemical Ind. having a D50 particle size of 0.3 μm.

Polysulfone, Udel P1700 NT LCD, a polysulfone resin available from SOLVAY.

Glycerol, a pore widening agent, commercially available from MOSSELMAN.

NEP, N-ethyl-pyrrolidone, commercially available from BASF.

Measurements

The Specific Ionic Resistance (ohm.cm) is measured with an Inolab® Multi 9310 IDS apparatus available from R, part of Avantor.

### Example 1

### Preparation of the Separators S-1 to S-7

A dope solution was prepared by mixing the ingredients of Table 1.

TABLE 1

| Ingredients (wt %) | Dope-1 | Dope -2 | Dope -3 | Dope -4 | Dope-5 | Dope- 6 | Dope-7 |
|---|---|---|---|---|---|---|---|
| ZrO₂(1) | 40.65 | — | — | — | — | — | — |
| ZrO₂(2) | — | 40.65 | — | — | — | — | — |
| BaSO4(1) | — | — | 40.65 | — | — | — | — |
| BaSO4(2) | — | — | — | 40.65 | — | — | — |
| BaSO4(3) | — | — | — | — | 40.65 | — | — |
| BaSO4(4) | — | — | — | — | — | 40.65 | 44.00 |
| Polysulfone | 12.835 | = | = | = | = | = | 11.00 |
| Glycerol | 1 | = | = | = | = | = | = |
| NEP | 45.515 | = | = | = | = | = | 44.00 |

The separators S-1 to S-7 were prepared as schematically depicted in FIG. 2.

The dope solutions were coated on both sides of a 1.7 m wide PPS-fabric using slot die coating technology at a speed of 1 m/min.

The coated support was then transported towards a water bath (coagulation bath, 800) kept at 65° C.

A VIPS step was carried out before entering the water bath in an enclosed area (400, d=7 cm, RH=98%, no ventilation).

The coated support then entered the water bath for 5 minutes during which a liquid induced phase separation (HIPS) occurred.

After an in-line washing step at 70° C. during 15 minutes in water, the obtained separator was rolled up without drying, and afterwards cut in the desired format.

The obtained separators S-1 to S-6 all had a total thickness of 500 μm.

The Specific Ionic Resistance (RIS) of the separators S-1 to S-6, measured as described above, are shown in Table 2.

TABLE 2

| | Inorganic | D50 inorganic | RIS |
|---|---|---|---|
| Separator | particle | particle | (ohm · cm) |
| S-1 (COMP) | Zr02 | 0.3 | 2.6 |
| S-2 (COMP) | Zr02 | 1.2 | 3.0 |
| S-3 (COMP) | BaSO4 | 3 | 10.2 |
| S-4 (COMP) | BaSO4 | 1 | 4.7 |
| S-5 (INV) | BaSO4 | 0.7 | 3.8 |
| S-6 (INV) | BaSO4 | 0.3 | 2.7 |
| S-7 (INV) | BaSO4 | 0.3 | 2.4 |

From the results in Table 2 it is clear that the Specific Ionic Resistance of the separators including BaSO₄ as hydrophilic inorganic particle having a D50 particle size lower than or equal to 0.7 μm is comparable with those of the separators including ZO2 as hydrophilic inorganic particle. It is also observed that with ZrO2 the Specific Ionic Resistance is less dependent on the particle size. It has also been observed that the Specific Ionic Resistance of a separator including BaSO₄ particles having a D50 particle size of 0.3 μm further decreased. Also an increasing weight ratio of BaSO₄ particles to polymer resin results in a further decrease of the Specific Ionic Resistance.

1-15. (canceled)

16. A separator for alkaline water electrolysis comprising a porous hydrophilic polymer layer, the porous hydrophilic polymer layer comprising a polymer resin and hydrophilic inorganic particles, wherein the inorganic particles are barium sulfate particles having a particle size D50 of 0.7 μm or less.

17. The separator of claim 16, wherein the amount of barium sulfate particles is at least 50 wt % relative to the total amount of polymer resin.

18. The separator of claim 16, further comprising a porous support.

19. The separator of claim 18, comprising two porous hydrophilic polymer layers contiguous with both sides of the porous support, the porous hydrophilic polymer layers comprising a polymer resin and barium sulfate particles having a particle size D50 of 0.7 μm or less.

20. The separator of claim 16, wherein the polymer resin is selected from the group consisting of polysulfone, polyethersulfone, and polyphenylsulfone.

21. The separator of claim 16, wherein the porous hydrophilic layer has a maximal pore diameter between 0.05 and 2 μm.

22. A method of preparing a separator for alkaline water electrolysis according to claim 16, the method comprising the steps of:
applying a dope solution comprising a polymer resin, barium sulfate particles having a particle size D50 of 0.7 μm or less, and a solvent on a substrate, and
subjecting the applied dope solution to phase inversion.

23. The method of claim 22, wherein the substrate is a porous support.

24. The method of claim 22, wherein the dope solution is applied on either side of the porous support.

25. The method of claim 22, wherein the solvent of the dope solution is selected from N-methyl-2-pyrrolidone (NMP), N-ethyl-pyrrolidone (NEP), N-butyl-pyrrolidone (NBP), N,N-dimethylformamide (DMF), formamide, dimethylsulfoxide (DMSO), N,N-dimethylacetamide (DMAC), acetonitrile, and mixtures thereof.

26. The method of claim 22, wherein the dope solution further comprises polyvinylpyrrolidone or glycerol.

27. The method of claim 22, wherein the phase inversion step includes a Vapor Induced Phase Separation (VIPS) step and a Liquid Induced Phase Inversion (LIPS) step.

28. The method of claim 27, wherein the LIPS step is carried out in a coagulation bath comprising water.

29. The method of claim 22, wherein the porous support is transported in a vertical positon in the application step and the phase inversion step.

30. An alkaline water electrolysis device comprising a separator accordingly to claim 16 located between a cathode and an anode.
